(19) United States
(12) Patent Application Publication
(10) Pub. No.: US 2004/0063081 A1
(43) Pub. Date: Apr. 1, 2004

(54) Interactive game and method for modifying behaviors

(76) Inventor: Susan Lipkins, Sands Point, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/255,472

(22) Filed: Sep. 26, 2002

(51) Int. Cl. G09B 19/00

(52) U.S. Cl. 434/236; 434/128

(57) ABSTRACT

An interactive game designed to effectively and positively modify and improve a variety of behaviors of a player by increasing behaviors which supervisors approve of and decreasing behaviors which are inappropriate via integration of both positive and negative reinforcement. Simultaneously, a game according to the present invention modifies the behavior of the supervisor as well as the player by giving him/her an effective and emotionally neutral way to modify behavior which is orderly and clearly communicates to the player. Furthermore, the game can be played with multiple players simultaneously as opposed to requiring a separate chart/game board for monitoring behavior of each player, can be customized to provide appropriate rewards/punishment according to the specific desires of each player/supervisor, accordingly, and is continually adaptive in accordance with the changing individual needs of each player and supervisor.

### BACKGROUND OF THE INVENTION

1. Technical Field

The present invention relates generally to the field of behavioral psychology, and more particularly, to an interactive game and method for modifying behavior to increase the incidence of desirable behavior while decreasing the incidence of behaviors which are undesirable.

2. Description of Related Art

Behavioral psychology is based on theories about learning introduced by psychologists, for example, such as Hull, Thorndike and Skinner. Hull believed that one is motivated to learn in order to satisfy a need, such as hunger. Thorndike stated that a behavior will become strengthened or habitual if it is positively reinforced. Under this concept, if a behavior is positively reinforced (i.e., rewarded), immediately after it occurs, it is likely to occur again. Rewarding a spontaneous behavior is the key to reinforcing the behavior and the key to change. For example, though there may be significant sibling rivalry in a family, the moment that the older child spontaneously helps his younger brother, that behavior should be rewarded in order to reinforce the concept of being a “caring big brother.” Conversely, punishment is another concept that helps modify behavior. For example, if a child is punished immediately after exhibiting a certain behavior, that behavior is unlikely to occur again.

Skinner introduced the idea of pairing positive reinforcement (such as food) with a verbal response (such as praise.) He also said that responses that were intermittently reinforced (instead of reinforced every time) were particularly effective. He introduced the concept of “shaping,” in which behavior which is close to, but not exactly the required behavior, is reinforced in small steps. Shaping behavior is a concept in which as one is teaching a new behavior, approximations of the desired behavior are deemed sufficient and rewarded. For example, when teaching a child to throw a ball and catch it, one would not expect the child to catch it each time. As they practice, their ability to catch will improve; however positive reinforcement is given every time they try. Skinner believed that learning is generalized, so that it is not just specific to a particular learning paradigm.

Motivation is an important concept in learning. Generally, there are two types of motivation—intrinsic and extrinsic. For example, a child's intrinsic motivation is his/her own desire to be independent. One cannot give a child intrinsic motivation. Extrinsic motivation is the act of giving positive reinforcement to someone for something they have done. Therefore, extrinsic motivators must be objects or experiences that are significant to the person you are trying to motivate. For example, if an employee is given a medal each week, instead of a paycheck, it is unlikely that he/she will show up for work the following week. However, if you tell an employee that he/she will get more pay or an extra vacation day if they work one hour longer, it is likely that they will perform the desired behavior. While each of these theories differ slightly, they all agree on the concept that behavior can be modified through conditioning, rewards, and punishment. These theories have been separately utilized in a variety of settings in systems for changing the behaviors of animals as well as people. However, typically, these systems are designed to work on only one specific behavior (e.g., nail-biting, smoking, or toilet training) of an individual and are designed to use only one element of the above theories.

Furthermore, conventional methods of modifying behavior, for example, of a child by a parent, often result in frustration and is overall, a negative experience for both parties. For example, busy parents frequently have short fuses and feel stressed and overwhelmed, and thus they often react by screaming, threatening, hitting, or over-punishing a disobedient child. However, such actions are quite detrimental for both parent and child.

Accordingly, an efficient, accurate and adaptive technique for integrating multiple behavioral theories to most effectively and positively modify a variety of behaviors of multiple individuals simultaneously, is highly desirable.

### SUMMARY OF THE INVENTION

The present invention is a game designed to effectively modify and improve a player's (e.g., child's) behavior by encouraging and thus increasing behavior which supervisors (e.g., parents) approve of and discouraging and thus decreasing behavior which is inappropriate. Simultaneously, the game changes the behavior of the supervisor (e.g., parent) by giving him/her a new way to discipline which is orderly and clearly communicates to the player (e.g.,child). Thus, the supervisor's patience is increased and there is a decrease in the supervisor's negative “yelling, threatening and hitting” behavior.

Several elements of the game are flexible and require forethought, interaction and communication. For example, each player suggests objects and special events that are important for him/her to have and/or experience. This is a vital part of the game, as it is evident that people will not be motivated to do something if the reward is not of interest to them. Negotiation between supervisor and player will occur in order to create such a list, which can be revised as the rewards are achieved and/or the needs of the players change. Likewise, the supervisor must consider his/her values (and preferably compare them with the values of other supervisors, if any) in order to develop a list of possible “consequences” which preferably vary in intensity and duration. At least one consequence, which is picked by the supervisor, is chosen to be imposed on a player as a “punishment” when that player's marker falls on a consequence position. Each consequence preferably varies according to the supervisor's perception of the appropriate punishment at that time for the situation at hand. Advantageously, unlike other typical methods of disciplining, the supervisor does not need to resort to threatening to elicit the desired behavior, since the list of possible consequences is in full view to the player(s) at all times.

In one aspect of the present invention, a game for modifying behavior is provided comprising a playing area having a plurality of playing positions arranged in a succession. The succession has a first segment denoting a positive result and a second segment denoting a negative result, a start position provided within the succession of playing positions, at least one rewards position within said first segment, and at least one consequences position within said second segment. A marker is provided for indicating a player's position on the succession of playing positions, and behavior exhibited by the player is assessed by a supervisor to determine movement of the marker on the succession of playing positions.

In yet another aspect of the present invention, a game board for playing a game to modify behavior is provided comprising a plurality of playing positions arranged in a succession. The succession has a first segment signifying positive achievements and a second segment signifying negative achievements, a start position provided in the succession of playing positions, at least one rewards position on said first segment, and at least one consequences position on said second segment. At least one playing piece is provided for each player. The game board also comprises a rewards area for displaying at least one reward for each player, a consequences area for displaying at least one consequence, and a rules area for displaying rules for playing the game.

In yet another aspect of the present invention, a method of playing a game for modifying behavior is provided comprising the steps of providing a playing area having a plurality of playing positions arranged in a succession having a first segment denoting positive achievements and a second segment denoting negative achievements. A marker is provided for each player for indicating the player's relative position along the succession of playing positions. A start position is provided in said succession of playing positions, at least one rewards position is provided on said first segment, and at least one consequences position is provided on said second segment.

A method of playing the game comprises placing said marker on the start position, wherein when each player exhibits a behavior further comprising the steps of a supervisor assessing the behavior, wherein if the behavior is appropriate, the supervisor moves the marker of the player towards the first segment denoting positive achievements, and wherein if the behavior is inappropriate, the supervisor moves the marker of the player towards the second segment denoting negative achievements. Next, it is determined if the marker has reached either of the rewards space and the consequence space. If the marker has reached the rewards space, the player wins and is allowed to select at least one reward. If the marker has reached the consequence space, the supervisor selects at least one consequence to be imposed on the player.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar elements throughout the views:

FIG. 1 shows an exemplary game board layout according to one embodiment of the present invention; and

FIG. 2 is an exemplary flow chart depicting a method of playing the game according to an embodiment of the present invention.

### DETAILED DESCRIPTION OF PREFERRED EMBODIMENTS

The present invention comprises a game that advantageously integrates all aspects of the above-mentioned behavioral theories, as well as twenty years of the inventor's professional clinical experience in private practice in the field of child psychology. The game advantageously modifies a variety of behaviors (vs. just one behavior) and is geared towards modifying the responses of both the player (e.g., child) and supervisor (e.g., parent), instead of just the player. In addition, the game can be played to modify the behaviors of multiple players (e.g., multiple members of the family) simultaneously as opposed to requiring a separate chart/game board for each player, and integrates both positive and negative reinforcement (vs. just using positive reinforcement).

In the present invention, “rewards” are not just objects, but could also be special events that the player would do with one special person, such as going out to breakfast alone with mom or going fishing with dad. This additional element improves the relationship between the parent(s) and each child and allows both parent and child to view “one on one time” as a special treat. In accordance with this, the game demands that the players and supervisors have extensive dialogue, in which both parties collaborate, negotiate and compromise as they develop a reward and punishment system which uniquely fits the specifics of each player, supervisor, and family. In addition, the rewards and punishments can be changed as time goes on and therefore, the game “grows” with the family. The game of the present invention can be used with all individuals (e.g., children, mentally-challenged people, etc.) preferably of ages 4 and up.

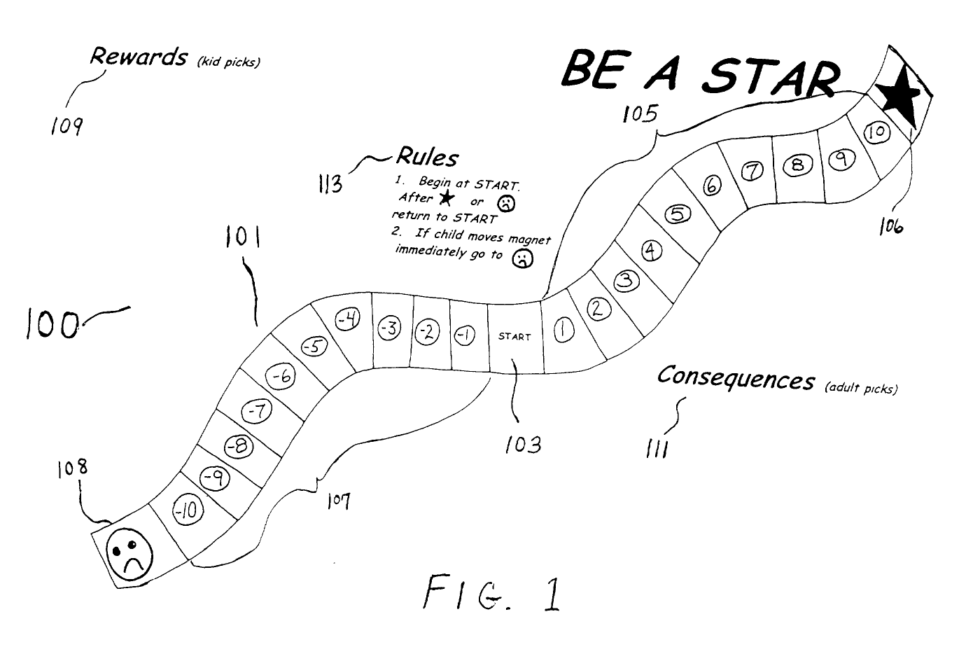

FIG. 1 shows an exemplary game board layout 100 according to one embodiment of the present invention. The game board is preferably made of a flexible, lightweight material having a surface which can be written on and a magnetic backing (for attaching to a metal surface, e.g., a refrigerator). For example, the board may comprise a plastic-coated washable surface which may be written on with water-soluble markers and wiped clean with a damp cloth for erasing the writing. Pre-printed on the game board is a succession of playing spaces 101 preferably arranged in a winding, curved shape as shown in FIG. 1. In this embodiment, the succession 101 comprises, for example, twenty-three playing spaces. A marker/playing piece is preferably designated/provided for each player for indicating a player's position on/along the succession of playing spaces 101.

In a preferred embodiment, a start position 103 is preferably designated in the center of the succession of playing spaces 101. In this embodiment, the spaces to the right of the start position 103 (positive segment 105) are preferably numbered in positive numbers and increase from left to right. The positive segment 105 denotes positive achievements/results of a player as the marker, for example, is moved up the positive segment 105. For example, in one embodiment, they are numbered consecutively one through ten, as shown here in FIG. 1. Preferably, the positive segment 105 is laid out to form a winding curve ultimately curving upwards. The last right space (rewards position 106) preferably has a picture of a star (or any other symbol acknowledged as/denoting a positive achievement). It is to be noted that the start position 103 may be located anywhere along the succession of playing spaces 101.

The spaces to the left of the start box (negative segment 107) are preferably numbered in negative numbers and decrease from right to left. The negative segment 107 denotes negative achievements/results of a player as his/her marker is moved, for example, down the negative segment 107. In one exemplary embodiment, as shown here in FIG. 1, they are numbered consecutively from negative one down through negative ten. Preferably, the negative segment 107 is laid out to form a winding curve ultimately curving downwards. The last left space (consequence position 108) preferably has a picture of an unhappy face (or any other symbol acknowledged as/denoting a negative achievement) to visually convey a negative result.

A rewards area listing 109 is preferably located in the top left hand side of the game board layout 100 for listing at least one (preferably more) objects and/or special events (i.e., “rewards”) desired by each player. Advantageously, the rewards area listing 109 provides a way of displaying the rewards list visually and conspicuously. The list may comprise, for example, about ten rewards (or more, depending on the number of players). The rewards list is preferably created-by both supervisor (e.g., parent) and player (e.g., child) together, and at least one reward from the list is picked by the player when the player achieves a “star” (i.e., wins by earning points such that his/her marker reaches the rewards position 106). The rewards preferably should be a mixture of objects (not too lavish) desired by the player and “special times” such as having breakfast at the diner alone with dad. These special times are important to both supervisor and player, and improves their relationship, communication, etc. For best results, the rewards should be things/events the player really wants. If several players are playing, the supervisor can increase the amount of possible rewards on the list, such that each player should preferably have at least 4 rewards from which to choose.

Furthermore, regardless of the ages of the players, all the possible desired rewards of each player can go on the same rewards list. For example, an older child might have on the rewards list, “staying up till 10 p.m.” while a younger child might have “a play date at the pool with Emily.” Though both choices are on the rewards list, the child will pick the reward that is important and relevant to him/her.

A consequences area listing 111 is preferably placed in the bottom right hand side for visually and conspicuously listing a number of consequences created by the supervisor/parent. At least one consequence from the list is preferably chosen by the supervisor and the player is made aware of the consequence chosen when the player achieves an “unhappy face” (i.e., ‘loses’ the game by losing points such that his/her marker falls on the consequence space 108). Preferably, the supervisor(s) should work together to create the list of consequences. In addition, the list of consequences should preferably vary in intensity and duration so that the supervisor has the maximum flexibility in appropriately punishing the player according to, for example, the level of inappropriateness of the player's behavior and/or what the supervisor feels is a suitable punishment at the time for the particular situation. For example, the consequences might be, e.g., having to go to bed 15 minutes early, having to go to bed 30 minutes early, no TV for 30 minutes, 60 minutes, all evening, all day, for one day or x number of days, etc. In addition, the consequence is preferably only imposed/enforced when a player's marker reaches the consequence position 108 (e.g., “unhappy face”). It is to be noted that the consequences should preferably not include punishments that are impossible to monitor or which would create stress for the supervisor. For example, it is not advised to use hitting or lack of a meal as a consequence, although losing sweets/dessert for a limited time is acceptable. The consequences are preferably explained verbally by the supervisor to each player and also written down in the consequences area listing 111. Thus, each player is informed of and made aware of the consequences both orally and visually.

The rules 113 are preferably written down in a conspicuous area (e.g., the center) of the game board 100 to provide visual awareness of same. Preferably, a first rule is that each player must begin at the start position 103, and after achieving either a star or an unhappy face (i.e., his/her marker reaches either the rewards position 106 or consequence position 108), must immediately return his/her marker to the start position 103. Preferably, a second rule is that if any player moves any marker, that player's marker will immediately go to the consequence position 108 (unhappy face). Advantageously, each of these rules induces desirable psychological effects. For example, the first rule encourages a player to gain control of and improve their behavior even if they have just been punished (i.e., they are immediately being given another chance). The second rule discourages cheating by the players.

The object of the game for each player is to get his/her marker to the rewards position 106. Once this is achieved that player can pick a reward from, for example, the rewards area 109, which is preferably given to the player as quickly as possible. Immediately following the achievement of getting a reward (as well as achieving, e.g., a “star”), the player's marker is placed on the start position 103, and the game can begin again. Preferably, there is no limit to the number of rewards (and “stars”) a player can earn. Furthermore, a variety of behaviors can be assessed/rewarded/punished accordingly, using the game of the present invention.

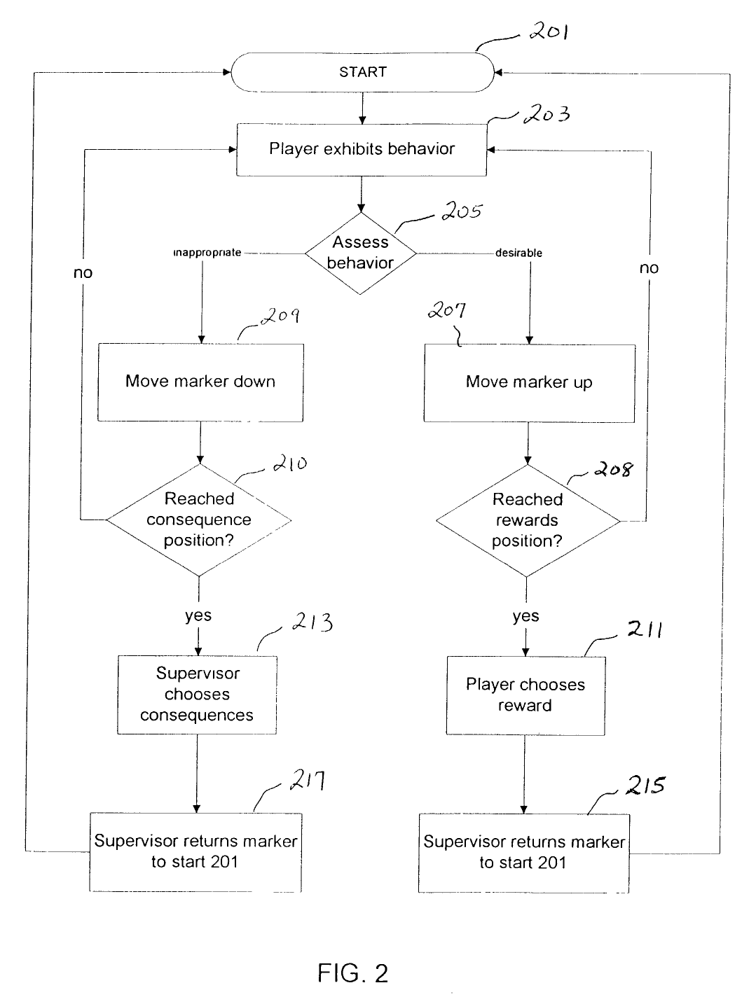

FIG. 2 is an exemplary flow chart depicting a method of playing the game according to an embodiment of the present invention. Each player is preferably assigned a marker (e.g., given a game piece). Initially, each marker is placed at the start position (step 201). As each player exhibits various behaviors (step 203), such behaviors are preferably monitored and assessed by at least one supervisor (step 205), who preferably ascertains whether they are desirable/appropriate behaviors which should be rewarded or inappropriate behaviors which should be punished.

According to an aspect of the present invention, desirable/inappropriate behaviors are first rewarded/punished, respectively, via a point system. It is the supervisor's choice as to what behaviors are to be rewarded with points and how many points a particular behavior is worth. If the behavior exhibited is desirable/appropriate, the supervisor, at his/her discretion, moves that player's marker up (step 207) towards the rewards position 106. The supervisor may move the marker any number of spaces (i.e., points) up at his/her discretion, depending, e.g., on how many points the supervisor deems that behavior to be worth. For example, when a parent (supervisor) says “turn off the TV and come to dinner” and the child (player) does so, the child can be given a point towards the star (rewards position 106).

If the behavior exhibited by the player is undesirable or inappropriate, the supervisor may, at his/her discretion, move the marker down (step 209) by any number of points, towards the consequence position 108. It is preferably the supervisor's choice as to what behaviors are to be punished with a loss of points as well as how many points should be lost for a particular behavior. For example, when a player (child) does something the supervisor (parent) does not approve of, the parent can simply tell the child, in an even-toned voice, “you just lost two points for doing that.” Then, the parent goes to the game board and lowers the child's marker by two points. Thus, instead of warning or threatening the child, the parent simply moves a marker on the game board, which is preferably displayed in a conspicuous area (such as the kitchen). If the child whines or complains about his/her marker being moved down, the parent can simply state that it is okay if the child wants to continue such behavior, however, the parent will simply continue to move the marker down if the child chooses to do so, and thus the child will continue to lose more points. Particularly, this element of the game typically stops the undesirable behavior. Advantageously, the fact that the child visually sees his/her marker moving up towards the star or down towards the unhappy face (consequence position 108), adds a visual dimension and tangible incentive to his/her effort to be in control and to behave properly.

It is to be noted that it is desirable to use language to verbally notify and clearly explain to the player why his/her marker is either being raised or lowered. Such explanations should preferably be short and easy to understand. Also, it is desirable to use differing amounts of points for rewarding/punishing various behaviors. For example, if you want to emphasize a particularly good behavior, the player's marker can be raised, for example, three points instead of one. Likewise, the player's marker may be lowered, for example, more than one point for punishing behavior which is especially undesirable. Thus, the game according to the present invention advantageously can be customized to provide an appropriate reward/punishment according to the specific behavior of each player.

At step 208, it is ascertained as to whether the marker has reached the rewards position 106. If yes, the player has achieved the objective of the game (i.e., “wins”) and is allowed to choose at least one reward (step 211) preferably selected from the rewards area listing 109. Every effort should be made to give the reward to the player immediately or to negotiate when the reward will be received. The marker is then returned immediately to the start position 201 by the supervisor (step 215). If the marker has not reached the rewards position, the process returns to step 203, where further behaviors by each player are exhibited, assessed and either rewarded or punished via the point system.

Similarly, at step 210, it is ascertained as to whether the marker has reached the consequences position 108. If yes, the supervisor chooses at least one consequence for that player preferably selected from the consequences area listing 111 (step 213) and informs the player of the chosen consequence. The marker is then returned by the supervisor to the start position 201 (step 217). It is important that the supervisor actually follow through with the chosen consequence. However, immediately after at least telling the player what the consequence is, or after actually enforcing/imposing the consequence on the player, the player's marker is returned to the start position 103. The player's marker should never be left to linger on the consequence position 108, even if the consequence will not be implemented until a later time. In addition, it is to be noted that a consequence should not be imposed on a player unless the player's marker has reached the consequence position 108.

It is to be noted that as a player approaches the consequence space 108 (e.g., the unhappy face), their undesirable behavior may stop cold and turn around. It is preferable to immediately reward any positive change in the player's behavior. However, if the player, for example, is truly too tired and cranky to have any control of his/her behavior and thus is spiraling to the consequence space 108 too quickly, it is suggested that other tactics can be temporarily employed by the supervisor to prevent the player from failing too quickly and severely. For example, if the player is a child, the supervisor can stop the game and try to put the child to sleep. If, however, the child simply “loses control,” advantageously, the game according to the present invention allows the supervisor to choose a consequence that matches the way he/she feels is appropriate for the situation, rather than lose control as well. For example, if the supervisor is quite angry, then a consequence that is more intense can be chosen. If instead the supervisor feels that the player is simply too stressed to have control, then the supervisor can choose a lighter consequence.

According to another aspect of the present invention, appropriate/inappropriate behaviors are also rewarded/punished, respectively, with actual rewards (e.g., tangible objects or desired events given to the player) or consequences (e.g., punishments imposed on the player). It is to be noted that another embodiment of the present invention may comprise having multiple reward positions 106 and/or multiple consequence positions 108 anywhere along the succession of playing positions 101.

In accordance with the above-mentioned rules 113, it is to be noted that in a preferred embodiment, only the supervisor(s) are permitted to move the markers in the course of the game. If any player moves the markers, that player's own marker will be immediately placed on the consequence position 108 and the supervisor will then choose at least one consequence for that player.

In a game board embodiment, each playing piece is magnetic (for attraction to a metallic surface, e.g., through the game board, such that the marker can be maneuvered on the game board without falling off). In addition, each player (e.g., child) can be encouraged to decorate the various squares (playing spaces 101) of the game board 101, using, e.g., different colors or stickers for each space as desired. This adds interest and “personalizes” the game, increasing its importance to the player. It also provides another visual aid (e.g., colors and/or stickers in addition to the numbers) for the supervisor in case a marker is moved illegally (i.e., by someone else).

As soon as the player exhibits a behavior that the supervisor approves of and wants to reinforce, that player's marker is moved up the positive segment 105 as many playing spaces as the supervisor deems worthy. Thus, the player earns points towards the rewards position 106 (“star”) by behaving in a way that the supervisor want to positively reinforce. Preferably, the supervisor simultaneously provides verbal praise for appropriate behavior and tells the player that their marker just went up, for example, one space towards the star (i.e., rewards position 106).

If, however, the player is exhibiting an undesirable behavior (e.g., is not listening), the supervisor has the opportunity to move that player's marker down towards the consequences space 108. Preferably, the supervisor chooses when to move the marker down, and chooses how many spaces down to move as well. Advantageously, a game according to an aspect of the present invention is adaptive to any changing desires of its players since, as the game continues, new rewards and consequences can be added as needed to keep the players sufficiently motivated as their needs change. Ideally, the players should be encouraged to be creative and think of rewards that they really want. It is to be noted that in, for example, large families which play the game, there should be at least, for example, four rewards that are special to each player.

It is preferred that when a player is first introduced to the game, that player is encouraged to reach the rewards position as soon as possible, (e.g., within two days) so that he/she develops an understanding of the game and is motivated to play. Once the player has received a few stars (i.e., reached the rewards position 106 a number of times) the supervisor can tailor the game so that it becomes slightly and progressively more difficult to achieve the rewards position. This concept continues as behaviors are achieved, and advantageously shapes the player's future behaviors in more desirable ways as it continually challenges the player to improve him/herself. For example, the first two times that the game is played it is preferable to try to have the player reach the “star” within the first 24-48 hours. In the beginning it is especially important to reward behaviors so that the player's intrinsic interest is increased. During this time period it is desirable to overemphasize the positive, and use punishment only if absolutely necessary. After the player has received, for example, at least two stars, the supervisor can start to reward and punish in a more realistic and conservative way. If possible, the first rewards (stars the child has earned and therefore chosen) should be given to the child as soon as possible.

The game according to the present invention advantageously positively affects and modifies the supervisor's behavior as well as the player's behavior, and thus, both the supervisors (e.g., parents) and the players (e.g., children) mutually benefit throughout the entire process of this game. The game increases the verbal interaction between parent and child, and the goals of the parent become clarified to both the parent and child. As the communication and interaction between parent and child improves, the entire dynamic of a family can change for the better.

Advantageously, a game according to the present invention gives the supervisor (e.g., parent) a structured, positive method of discipline which is emotionally neutral and thus more effective, since it helps increase the supervisor's patience. By using the game according to the present invention appropriately and consistently, the supervisor feels in control and less emotional. Indeed, as the parent feels more in control and thus stabilizes his/her behavior, the child feels less anxious and perceives family life as being “more fair.” Accordingly, the self-esteem of both child and parent is preserved and enhanced as the dynamic between them improves and each will feel more positively about him/herself and others. Also, both supervisor and player will increase their self-control with respect to each other.

Furthermore, the game according to the present invention is a simple, flexible, continually adaptive and individualized method of improving behaviors. It is also portable, so it can be taken anywhere (e.g., on vacation). The rules are simple and easily understood, even by very young players or e.g., mentally-disabled patients. In addition, the game can be played in any language, with people of any educational or cultural background. A booklet is preferably included which explains the principles of the game and gives examples. While the booklet is geared towards supervisors, one part should preferably be specifically written for the players.

Overall, a game according to the present invention advantageously rewards a child for positive behavior while simultaneously providing emotionally neutral negative reinforcement for undesirable behavior. Moreover, the game provides a multi-tiered reward system, namely, the reward of acquiring points (which can be seen concretely on the game board,) an actual reward once a sufficient number of points have been collected by the player (the actual reward can be a tangible object, an enjoyable event, etc), and verbal praise (which should always accompany the rewarding of points as well as the actual reward). Preferably, each player should clearly understand why he/she earned points. In addition, it is important that the actual reward is a thing/experience that the player truly wants, and is thus motivated by. In addition, the game provides a multi-tiered punishment system, namely, the ‘punishment’ of losing points, as well as an actual punishment (consequence) that is enforceable on the player.

Further, the method according to the present invention by which a player is given an actual reward only when a certain amount of points have been earned has the effect of delayed gratification, which advantageously develops and promotes other desirable behavioral qualities in the player, such as patience, working towards and achieving a goal, etc.

The present invention advantageously provides a simple yet effective visual gauge for each player, thus enabling him/her to assess the current situation quickly and clearly. For example, as the player sees his/her marker traveling down the game board, heading to the “unhappy face” (i.e., consequence position 108), he/she is more clearly able to visualize that what he/she just did is not a behavior to be repeated, as it brings him/her closer to an undesirable result. This can have the effect of changing the player's behavior. According to one contemplated embodiment, the supervisor (e.g., parent) should take the points away from the player without threats or warnings. For example, in an even voice the supervisor should say, “You lost a point for whining. If you want to whine that is fine, but you will continue to lose points by doing so.” Such actions are particularly advisable when the player is just beginning to learn how to play the game, since he/she will almost always protest/whine the first time that his/her marker is moved downwards (i.e., towards the consequence position).

In addition, the present invention advantageously rewards behavior that is close to, but not exactly the desired behavior. This helps shape appropriate and desirable behaviors. For example, if you would like a child to do their homework independently, each time they attempt to do something without your assistance, they could receive a point. Eventually, the child will be able to do his homework “all by him/herself.” The child will feel good about him/herself (increased self-esteem) and will be positively reinforced by the points as well as the verbal praise, and eventually by an actual reward earned from achieving a star. Unlike other behavior modification tools which only use rewards or only work on one previously-defined behavior (e.g., such as brushing teeth), a game according to the present invention allows the supervisor to monitor/improve many different kinds of behavior of each player (e.g., child) simultaneously, some of which are not concrete (e.g., like teeth-brushing) but which are important in building relationships (e.g., like showing respect). Thus, the present invention promotes conversation and interaction among the participants and requires negotiation, compromise and delayed gratification. Children, for example, often enjoy the game because they feel that they are being treated more “fairly” (e.g., by their parents) in the course of the game.

The types of behaviors supervisors (e.g., parents) may want to positively reinforce using a game according to the present invention can be determined by the supervisor depending on each player's (e.g., child's) age, stage, and/or the kind of behavior that really irritates the parent. For example, for young children, one type of behavior which is desirable to work on might be “listening behavior.” For example, in conventional settings, when parents tell children to turn off the TV, often the children fail to even respond to the request, much less perform it. The parents thus make multiple requests and become more and more angry.

In this situation, the game according to the present invention can be applied in the following way: when the child is told to turn off the TV but refuses, the parent simply goes to the game board and tells the child his/her marker will be moving down (towards the consequence space) because he/she is not turning off the TV. The child might not notice. If the parent asks again and the child still does not pay attention, the parent again puts the child's marker down. The parent preferably informs them that they are going down each time you make a request and they don't pay attention. If, however, the parent asks again and this time the child turns off the TV, the parent can reward them with a point up for obeying the request. Thus, the next time the parent asks them, they will probably turn off the TV right away. When the parent feels that “good listening” behavior is truly integrated into a child's behavior patterns, the parent can subtly stop rewarding for this. Thus, although you probably will be rewarding them for several behaviors in a day, not all behaviors get rewarded. For example, milestones that have already been achieved by a player (e.g., such as going to school) are not rewarded. It is the supervisor's choice which behaviors to reward or punish.

The following represent contemplated suggestions for improving the results of playing the game of the present invention:

1. Don't give up on the game too soon;

2. Supervisors should not necessarily try to reinforce all behaviors, just those that are the most significant to that supervisor;

3. If you stop using the game for some time you can always begin again. It is the supervisor's (e.g., parent's) interest and enthusiasm that really allows the game to succeed;

4. Do not use only the positive reinforcement; use the negative as needed;

5. Do not get into a negotiation with the player (e.g., child) about how many points something is worth, however try to be consistent;

6. For best results, supervisors should follow the rules of the game and be enthusiastic and consistent. However, if the game is losing effectiveness, it is probably due to the following reasons:

a. the rewards are not really what the player wants;

b. the punishments are not appropriate (perhaps they are too severe?); and

c. the rules are not being followed consistently.

7. If the player seems to be losing interest, the supervisor may employ various other tactics to motivate the player. For example, the supervisor may have a “sale” on points, e.g., for one day only a player can get double points for everything ‘good’ that he/she does, or for a specific behavior the player will get three points; and

8. Sometimes supervisors feel uncomfortable rewarding behaviors concretely; thinking that players (e.g., children) should “just behave.” Although this is a wish that most supervisors (e.g., parents) have, it is not a reality that many parents enjoy. Indeed, the act of rewarding positive behavior is part of human and animal nature. This game provides an adaptive and effective way to help both parent and child achieve better behavior overall.

It is to be understood that the exemplary apparatus and method steps described herein may be implemented in various forms of hardware, software, firmware, special purpose processors, or a combination thereof. For example, the present invention can be implemented in software as an application program tangibly embodied on one or more program storage devices. The application program may be executed by any machine, device or platform comprising suitable architecture. It is to be further understood that, because some of the constituent apparatus components and method steps depicted in the accompanying Figures can be implemented in software, the actual connections between the apparatus components (or the process steps) may differ depending upon the manner in which the present invention is programmed. Given the teachings herein, one of ordinary skill in the related art will be able to contemplate or practice these and similar implementations or configurations of the present invention.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. A game for modifying behavior comprising:
a playing area having a plurality of playing positions arranged in a succession having a first segment denoting a positive result and a second segment denoting a negative result;
a start position provided within the succession of playing positions;
at least one rewards position within said first segment;
at least one consequences position within said second segment; and
a marker for indicating a player's position on the succession of playing positions,
wherein behavior exhibited by the player is assessed by a supervisor to determine movement of the marker on the succession of playing positions.

2. The game of claim 1, wherein the succession of playing positions comprises a curved row, wherein said first segment denoting a positive result curves upwards and the second segment denoting the negative result curves downwards.

3. The game of claim 1, wherein the start position is located between said first segment and said second segment.

4. The game of claim 1, wherein if the behavior exhibited by the player is assessed by the supervisor as being appropriate, the supervisor moves the marker towards the at least one rewards position.

5. The game of claim 1, wherein if the behavior exhibited by the player is assessed by the supervisor as being inappropriate, the supervisor moves the marker towards the at least one consequences position.

6. The game of claim 4, wherein if the marker has reached the at least one rewards position on the first segment denoting the positive result, the player is allowed to choose a reward from a rewards list.

7. The game of claim 5, wherein if the marker has reached the at least one consequence position on the second segment denoting the negative result, the supervisor chooses a consequence to be enforced on the player.

8. The game of claim 6, wherein after the player receives the reward, the marker is returned to the start position.

9. The game of claim 7, wherein after the player is informed of the consequence, the marker is returned to the start position.

10. A game board for playing a game to modify behavior comprising:
a plurality of playing positions arranged in a succession having a first segment signifying positive achievements and a second segment signifying negative achievements;
a start position provided in the succession of playing positions;
at least one rewards position on said first segment;
at least one consequences position on said second segment;
at least one playing piece for each player;
a rewards area for displaying at least one reward for each player;
a consequences area for displaying at least one consequence; and
a rules area for displaying rules for playing the game.

11. The game of claim 10, wherein the succession of playing positions comprises a winding row, wherein said first segment denoting positive achievements curves upwards and the second segment denoting negative achievements curves downwards.

12. The game of claim 10, wherein the start position is located between said first segment and said second segment.

13. The game of claim 10, wherein if the behavior exhibited by the player is assessed by the supervisor as being appropriate, the supervisor moves the marker towards the at least one rewards position.

14. The game of claim 10, wherein if the behavior exhibited by the player is assessed by the supervisor as being inappropriate, the supervisor moves the marker towards the at least one consequences position.

15. The game of claim 13, wherein if the marker has reached the at least one rewards position on the first segment denoting the positive achievements, the player is allowed to choose at least one reward from the rewards area.

16. The game of claim 14, wherein if the marker has reached the at least one consequence position on the second segment denoting negative achievements, the supervisor chooses at least one consequence from the consequences area to be enforced on the player.

17. The game of claim 15, wherein after the player receives the at least one reward, the playing piece is returned to the start position.

18. The game of claim 16, wherein after the player is informed of the at least one consequence, the playing piece is returned to the start position.

19. A method of playing a game for modifying behavior comprising the steps of:
providing a playing area having a plurality of playing positions arranged in a succession having a first segment denoting positive achievements and a second segment denoting negative achievements;
providing a marker for each player for indicating the player's relative position along the succession of playing positions;
providing a start position in said succession of playing positions;
providing at least one rewards position on said first segment;
providing at least one consequences position on said second segment;
placing said marker on the start position, wherein when each player exhibits a behavior further comprising the steps of a supervisor;
assessing the behavior, wherein if the behavior is appropriate, the supervisor moves the marker of the player towards the at least one rewards position, and wherein if the behavior is inappropriate, the supervisor moves the marker of the player towards the at least one consequences position; and
determining if the marker has reached either of the rewards position and the consequence position, wherein if the marker has reached the rewards position, the player wins and is allowed to select at least one reward, and wherein if the marker has reached the consequence position, the supervisor selects at least one consequence to be imposed on the player.

20. The method of claim 19, wherein when the player has received the reward, the player's marker is returned to the start position.

21. The method of claim 19, wherein after the player is informed of the selected consequence, the player's marker is returned to the start position.

22. The method of claim 19, wherein the at least one reward is selected from a rewards area.

23. The method of claim 19, wherein the at least one consequence is selected from a consequences area.

24. The method of claim 19, wherein the succession of playing positions comprises a curved row, wherein said first segment denoting positive achievements curves upwards and the second segment denoting negative achievements curves downwards.

25. The method of claim 19, wherein the start position is located between said first segment and said second segment.
